(19) United States
(12) Patent Application Publication
(10) Pub. No.: US 2006/0204609 A1
(43) Pub. Date: Sep. 14, 2006

(54) HOT-CHANNEL DISTRIBUTION BLOCK FOR AN INJECTION MOLDING SYSTEM

(75) Inventor: Michael Goinski, Rodgau (DE)

Correspondence Address: ARTZ & ARTZ, P.C., 28333 TELEGRAPH RD., SUITE 250, SOUTHFIELD, MI, 48034, US

(73) Assignee: INCOE CORPORATION, Troy, MI (US)

(21) Appl. No.: 11/307,610

(22) Filed: Feb. 14, 2006

(30) Foreign Application Priority Data
Feb. 18, 2005 (DE) 10 2005 007 396.4

(51) Int. Cl. B29C 35/00

(52) U.S. Cl. 425/547; 425/573

(57) ABSTRACT

Hot-channel distribution block for an injection molding system which conducts the melt from the injection molding machine through flow channels to injection nozzles connected to the molding tools. Melt chambers are positioned adjacent the flow channels to the injection nozzles. Movable thrust pistons are placed in the melt chambers and, when actuated, force the melt present in the melt chambers at the required pressure into the tool cavities and into the flow-channel sections leading to it. The melt chambers can be positioned adjacent the connection or junction of flow channels.

### TECHNICAL FIELD

The present invention relates to hot-channel distribution blocks for an injection molding system.

### BACKGROUND OF THE INVENTION

In injection molding, the hot melt delivered by the injection molding machine is typically conducted by a hot-channel distribution block to a number of nozzles, which are connected to a mold (also called a “tool”). This may, for example, involve tools that have a plurality of cavities, where a nozzle is connected to each cavity, or may involve tools with large cavities in which two or more nozzles are connected to the same cavity. The hot-channel distribution block is heated during operation so that the melt (i.e. molten plastic material) is held at the temperature required for injection molding.

Injection molding can present a problem especially in the molding of small parts with thin wall thicknesses. Only a small amount of melt is required for the filling of the cavities for such parts. The result is that passage of the melt through the hot-channel distribution block takes a relatively long time. With a long melt dwell time in the heated hot-channel distribution block, the melt can be damaged by the long duration of the heating action, which can adversely affect the strength and appearance of the finished molded articles.

For injection molding of parts with thin walls, a relatively high pressure in the injection nozzles is also required in order to completely fill the cavity or cavities.

Shortening of the dwell time of the melt in the hot-channel distribution block may be achieved by providing the flow channels of the distribution block with smaller cross sections. However, in this system, the pressure loss of the flowing melt in the distribution block is high and the injection pressure in the nozzle mouth may not be sufficient to completely fill the cavity of the tool and at the correct injection velocity. On the other hand, if flow channels with large cross sections are selected, the dwell time of the melt in the hot-channel distribution block increases.

### SUMMARY OF THE INVENTION

The object of the present invention is to eliminate the problems described above, in particular in the injection molding of small thin-walled parts.

To accomplish this object, the present invention provides a hot-channel distribution block which overcomes these problems and produces an acceptable plastic injection molded product with thin walls. One or more pressure—controlled melt chambers are provided in or associated with the distribution block in order to provide adequate injection pressure and cavity filling.

The invention makes it possible, despite the use of hot-channel distribution blocks with small cross-sectional flow channels, to secure a sufficiently high injection pressure in the injection nozzle, particularly at the mouth or orifice.

To keep the number of the pressure-controlled melt chambers provided in the vicinity of the injection nozzles small, according to the present invention, they may preferably be provided at such points in the flow-channel system at which a flow channel branches into two or more adjacent injection nozzles.

Moveable thrust pistons are provided in the melt chamber particularly adjacent junctions or connections of flow channels leading to the injection nozzles. The thrust pistons are actuated by actuation mechanisms (e.g. hydraulic, pneumatic, or electric) and force the melt in the melt chambers through the injection nozzles and into the tool cavities at the requisite pressures.

### DESCRIPTION OF THE DRAWINGS

The invention is to be described in detail with reference to the drawings, wherein:

FIG. 1 is a schematic diagram of an exemplary embodiment of a flow-channel system in a hot-channel distribution block in accordance with the present invention.

FIG. 2 illustrates a part of an exemplary embodiment of a hot-channel distribution block according to the present invention.

### DETAILED DESCRIPTION OF THE PREFERRED EMBODIMENTS

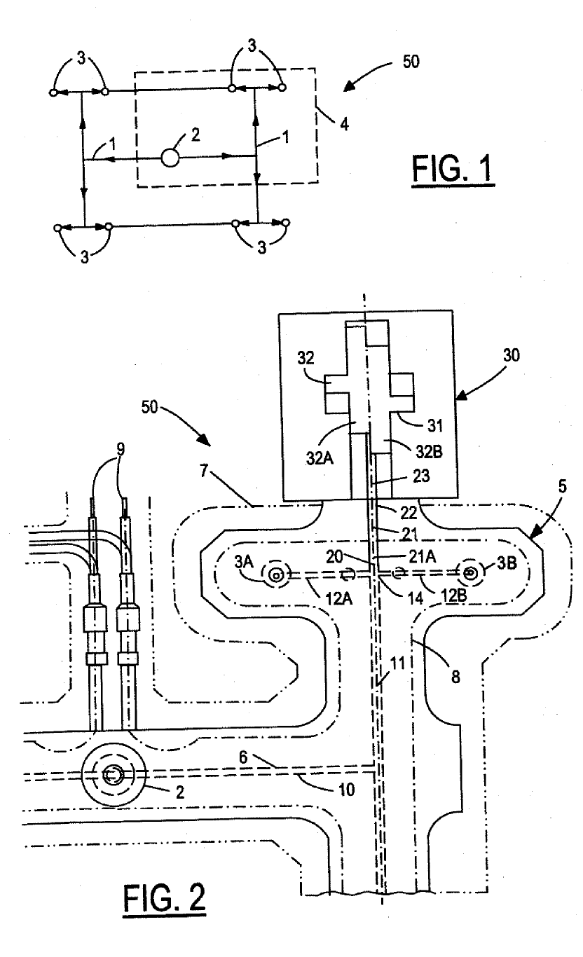

FIG. 1 shows, schematically in top view, an example of the course of flow channels 1 in a hot-channel distribution block 50. At 2 is found the connection of the injection molding machine. From there the melt flows, as indicated by the arrows, through the flow channels 1 to the nozzles 3, which are inserted into one or more tools. The “melt” is typically a molten resin or plastic material as known in the injection molding industry.

FIG. 2 shows an exemplary embodiment according to the invention of the outlined part 4 of the hot-channel distribution block 50 shown in FIG. 1. From the injection molding machine connected at 2 the hot melt 6 flows, inter alia, through the flow channels 10 and 11 to the junction or branching point 14 and from there via the flow channel sections 12A and 12B to the nozzles 3A and 3B, respectively, which are connected to the tool (mold). The contour of the tool is indicated by the dashed line 7.

In the exemplary embodiment shown, the branching point 14 is at the same time the connecting point of the melt chamber 20 according to the invention. The latter is formed of the inner end of a chamber bore 22, which extends from the outer point 23 of the hot-channel distribution block to the flow channel at the branching point 14. In the chamber 22 is found a displaceable thrust piston rod 21, the front end of which forms the thrust piston 21A in the melt chamber 20. The thrust piston rod 21 is actuated by an actuating mechanism 30, which in the example shown is designed as a hydraulically actuable piston-cylinder unit 31. The piston 32, with the thrust piston rod 21 fastened to it, is represented in FIG. 2 at the left 32A in its one end position and at the right 32B in its other end position.

During operation, an injection cycle proceeds as follows: at the beginning of the cycle, the thrust piston rod 21 is in its upper end position (in the direction of the drawing), so that the melt chamber 20 is released. When the molten resin is injection, the melt chamber 20 is filled with melt from the injection molding machine, while at the same time the melt is at the mouth of the nozzles 3A, 3B or some of it may already have been injected into the cavities (not shown). Then the thrust piston rod 21 moves into its lower end position 21A in the melt chamber 20 which exerts a strong pressure on the melt, which suffices to fill the cavities of the tool completely via the nozzles 3A, 3B and at the correct injection velocity. During the after-pressure and cooling time, and the ejection of the molded part from the tool, the thrust piston rod 21 is retracted and the melt chamber 20 refills with melt.

In its lowermost position in the direction of the drawing, the thrust piston rod 21A preferably projects into the center of the junction of the flow channels 12A, 12B. This measure prevents melt remaining at the lower end of the thrust piston 21A from being exposed to the high temperature prevailing in the hot-channel distribution block for too long a time and being burned, resulting in the formation of black particles. These particles could detract from the appearance of the finished molded parts. In this regard, preferably the end of the thrust piston rod should at least be in line with the surfaces of the walls of the flow channels 12A, 12B.

The dashed line 8 indicates the path of the tubular electrical heating member in the hot-channel distribution block. The electrical heating connections are referred to by the reference number 9.

The invention is not limited to the exemplary embodiment shown. Thus, for example, on the one hand each injection nozzle may have its own melt chamber 20 with its own actuating mechanism 30 and, on the other hand, a melt chamber may optionally alternatively supply more than two injection nozzles.

Melt chamber 20 and the end of the thrust piston rod 21 may alternatively be designed so that their diameters are greater than the diameter of the chamber bore 22 and the stem or shaft of the thrust piston rod 21.

In the exemplary embodiment shown, the actuating mechanisms 30 is directly mounted, for example by screw connection (not shown), onto the hot-channel distribution block 50. This fixed connection may in principle alternatively be omitted. The actuating mechanism can also alternatively be positioned in a cavity or bore in the block. The actuating mechanism 30 likewise need not necessarily be hydraulic in nature, but could be pneumatic, electric, or any other actuator means known in the art.

While various embodiments of the invention have been shown and described, numerous variations and alternate embodiments will occur to those skilled in the art. Accordingly, it is intended that the invention be limited only in terms of the appended claims.

What is claimed is:

1. An injection molding system comprising a hot-channel distribution block, at least two injection nozzles connected to said distribution block, at least one flow channel in said distribution block for conveying molten plastic material through the distribution block and through the injection nozzles into a mold cavity, and an actuation mechanism connected to the distribution block, said flow channel dividing at a junction into two secondary channels, one secondary channel connected to each of said two injection nozzles, a melt chamber positioned adjacent said junction, a movable thrust piston positioned in said actuation mechanism and having a thrust member positioned in said melt chamber, wherein actuation of said actuation mechanism moves said thrust member in said melt chamber and forces molten plastic material therein into said two secondary channels.

2. The injection system molding of claim 1 wherein said thrust piston is actuated by a mechanism situated from the group comprising a hydraulic mechanism, pneumatic mechanisms and an electric mechanism.

3. The injection system molding of claim 1 wherein actuation of said actuation mechanism moves at least part of said thrust into said two secondary channels.

4. The hot-channel distribution block according to claim 1, wherein said thrust piston is actuated by an actuating mechanism fixedly connected to the hot-channel distribution block.

5. The hot-channel distribution block according to claim 4, wherein said actuating mechanism comprises a hydraulic, pneumatic or electrical mechanism.

6. A hot-channel distribution block for an injection molding system which conducts molten plastic material from an injection molding machine through flow channels to at least two injection nozzles connected to injection molding tools, said hot-channel distribution block comprising one or more flow channels for passing plastic material to said injection nozzle, a melt chamber in flow communication with said flow channels, and a movable thrust piston for forcing molten plastic material present in the melt chamber at the required pressure through said flow channels and injection nozzles and into one or more tool cavities.

7. The hot-channel distribution block according to claim 6, wherein said the melt chamber is formed at the inner end of a chamber bore which is positioned in said hot-channel distribution block adjacent to a junction of two flow channels, the thrust piston having a thrust member displaceable in the said chamber bore.

8. The hot-channel distribution block according to claim 7 wherein said thrust member at the end of the pressure stroke, projects into the flow channels to the assigned injection nozzles.

9. Hot-channel distribution block according to claim 6 wherein the melt chamber is flow connected to said junction.

10. An injection molding system comprising a hot-channel distribution block, at least one injection nozzle connected to the distribution block, at least one flow channel in said distribution block for conveying molten plastic material through the distribution block and through the injection nozzle into a mold cavity, and an actuation mechanism connected to the distribution block, a melt chamber positioned in communication with said flow channel, a machine thrust piston positioned in said actuation mechanism and having a thrust member positioned in said melt chamber, wherein actuation of said actuation mechanism moves said thrust member in said melt chamber and forces molten plastic material therein into said flow channel, which in turn forces plastic material in said flow channel into said injection nozzle and into said mold cavity to completely fill said mold cavity.

11. The injection molding system according to claim 10 wherein said thrust piston is actuated by a mechanism selected from the group comprising a hydraulic mechanism, pneumatic mechanism and an electronic mechanism.
